(19) United States
(12) Patent Application Publication
(10) Pub. No.: US 2008/0106364 A1
(43) Pub. Date: May 8, 2008

(54) Spiral-shaped closed magnetic core and integrated micro-inductor comprising one such closed magnetic core

(75) Inventors: Bastien Orlando, Les Pennes Mirabeau (FR); Bernard Viala, Sassenage (FR)

Correspondence Address: OLIFF & BERRIDGE, PLC, P.O. BOX 320850, ALEXANDRIA, VA, 22320-4850, US

(73) Assignees: COMMISSARIAT A L'ENERGIE ATOMIQUE, Paris (FR); CENTRE NATIONAL DE LA RECHERCHE SCIENTIFIQUE, Paris (FR); STMICROELECTRONICS SA, Montrouge (FR)

(21) Appl. No.: 11/907,215

(22) Filed: Oct. 10, 2007

(30) Foreign Application Priority Data
Nov. 7, 2006 (FR) 06 09714

(51) Int. Cl. H01F 27/24

(52) U.S. Cl. 336/212

(57) ABSTRACT

The closed magnetic core is designed for use for an integrated micro-inductor. The magnetic core has the form of a spiral preferably substantially rectangular spiral. The spiral comprises two ends joined to one another by a closing segment. The magnetic core can be formed by a plurality of branches and at least two branches can be arranged in different parallel planes. In addition, two branches can have different thicknesses. The magnetic core can comprise an air-gap.

### BACKGROUND OF THE INVENTION

The invention relates to a closed magnetic core for an integrated micro-inductor.

### STATE OF THE ART

The invention relates to the field of integrated micro-inductors for power electronics applications. It can, in a more general manner, apply to all inductive systems (inductors, transformers, magnetic recording heads, actuators, sensors, etc . . . ) requiring a high electric power density.

Micro-inductors of various types using spiral or solenoid type coils have existed for a number of years. However, discrete components remain to a very great extent mainly used in applications using high power densities, as they offer the best trade-off between inductance and saturation current.

A coil of spiral type with a magnetic plane is easy to integrate and enables strong currents to be worked. However, this type of device becomes very cumbersome when high inductance values are sought for (L about μH), because a large number of turns are required. In addition, the resistance of such devices is high.

Toroidal integrated micro-inductors with a solenoid coil, and improvements thereof in meanders (see the article “Integrated Electroplated Micromachined Magnetic Devices Using Low Temperature Fabrication Processes” by J. Y. Park et. al., IEEE Transactions on Electronics Packaging Manufacturing, Vol. 23, n°0.1, 2000) are directly inspired by discrete components and present the best possible trade-off between resistance and inductance level, as they come close to the ideal case of the infinite solenoid. However, simulations show that the magnetic flux inside the core is distributed in very non-homogeneous manner. The magnetic field is more intense along the shortest field lines. The zones of the magnetic core subjected to the most intense fields are very quickly saturated, causing a reduction of the inductance straight away at very weak currents, whereas other zones are subjected to much weaker fields and take part to a very small extent or not at all in the inductive phenomenon, i.e. they do not make any contribution to the inductance value. The useful zones of the magnetic core are therefore very quickly saturated whereas other zones remain non-solicited.

Moreover, the maximum power flowing in an inductor is determined by the volume of magnetic material used in the case of an integrated component. This volume is determined by the thickness of magnetic material (thicknesses of less than 100 microns for integrated components) and the surface occupied by this magnetic core.

Transformers and inductors with a magnetic core in the shape of an E or E-I are widely used in electrical engineering, essentially in discrete transformers (and in discrete DC/DC devices) to facilitate assembly and coiling of the inductors, or to be able to adjust the conversion factors between the three windings of each branch, or the mutual inductances effects between the different windings of each branch (see the article “New Magnetic Structures for Switching Converters” by S. Cuk, IEEE Transactions on Magnetics, Vol. MAG-19, n°2, 1983). In these devices, the coiling is not continuous from one branch to the other, but is achieved by different wires.

Most of the micro-inductors used on the market are discrete components manufactured by micro-mechanical methods of micro-machining, sticking, micro-winding, etc . . . . These methods are cumbersome to implement, require individual treatment, are far from flexible in terms of design, and greatly limit miniaturization of the power circuits. In particular, the thickness of the discrete micro-inductors (typically greater than 0.5 mm) does not enable the power supply circuits currently used for mobile telephony, for example, to be suitably incorporated in a chip.

The manufacturing techniques used in microelectronics provide a much greater flexibility as far as implementing different designs is concerned, enable collective treatment to be performed, and are compatible with the idea of miniaturization, as the thickness (substrate included) can easily be less than 300 μm. However, they are not suitable for depositions of large thicknesses (greater than 10 μm) of magnetic, dielectric or conducting materials and for etching of these materials after photolithography.

For integrated components, technological manufacturing constraints constitute a limitation. Indeed, depositing conducting layers having a thickness larger than 100 micrometers is not for the moment envisageable in a standard industrial process.

The article “Numerical Inductor Optimization” by A. von der Weth et al. (Trans. Magn. Soc. Japan, Vol. 2, No. 5, pp. 361-366, 2002) describes a micro-inductor with an open magnetic circuit of multi-branch type. A plurality of turns not joined to one another forms a coil around the branches of the magnetic core. For these devices, it is sought to increase the inductance level and to minimize losses.

Integrated micro-inductors generally present an inductance that decreases greatly when the current applied to the turns of the micro-inductor is increased, even for weak currents, which makes it compulsory to use non-integrated discrete inductors in certain cases.

Microelectronic chips of small dimensions (a few square millimeters) are generally square in shape. Integrating inductors therefore imposes constraints that do not arise for discrete components. The solutions proposed are therefore often complex. For the inductors in particular, it is sought to minimize the occupied surface, all the more so as the use of thin film deposition techniques greatly limits the useful thicknesses. The power of an inductor LIₛₐₜ² (L being the inductance and Iₛₐₜ the saturation current) does in fact depend directly on the volume of magnetic material available.

### OBJECT OF THE INVENTION

One object of the invention is to increase the compactness of a core of an integrated micro-inductor and to increase the inductance value, for given overall dimensions.

According to the invention, this object is achieved by the magnetic core according to the appended claims and more particularly by the fact that the magnetic core is in the form of a spiral comprising two ends joined to one another by a closing segment.

It is a further object of the invention to provide an integrated micro-inductor comprising a magnetic core according to the invention.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 represents a particular embodiment of a closed magnetic core according to the invention, in perspective view,

FIGS. 2 to 4 respectively illustrate, in top view, two closed magnetic cores according to the prior art and a particular embodiment of the closed magnetic core according to the invention,

FIG. 5 represents a particular embodiment of the invention, in cross-section along the line A-A of FIG. 4,

FIG. 6 represents a particular embodiment of a closed magnetic core according to the invention, in top view,

FIG. 7 illustrates a particular embodiment of an integrated micro-inductor according to the invention.

### DESCRIPTION OF A PREFERRED EMBODIMENT OF THE INVENTION

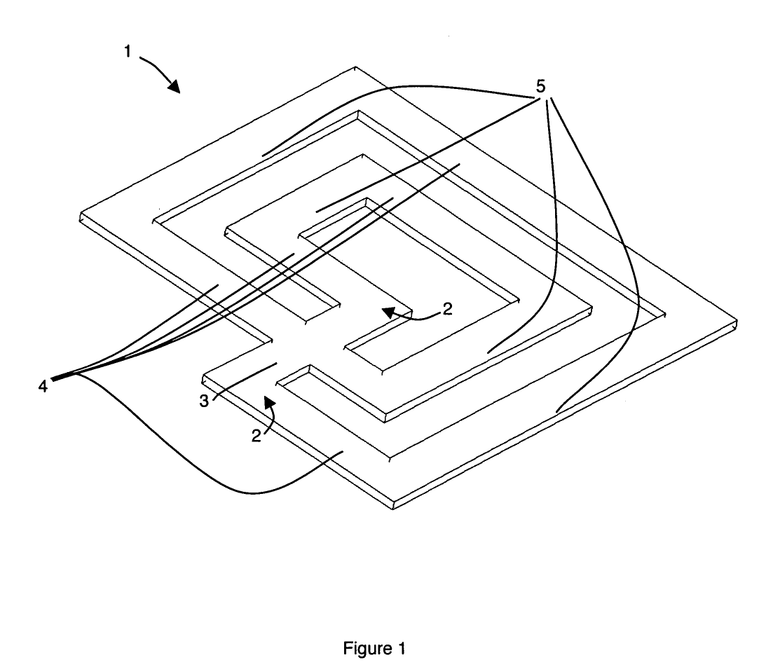

The magnetic core 1, represented in FIG. 1, is in the form of a spiral. The spiral comprises two ends 2 joined to one another by a closing segment 3. The magnetic core 1 is thus closed.

In FIG. 1, the magnetic core 1 is formed by a first set 4 of five parallel branches and a second set 5 of four parallel branches substantially perpendicular to the branches of the first set 4. The spiral formed by all of the branches of the two sets 4 and 5 is thus rectangular. The connection formed by the closing segment 3 is added to the spiral to form the magnetic core 1.

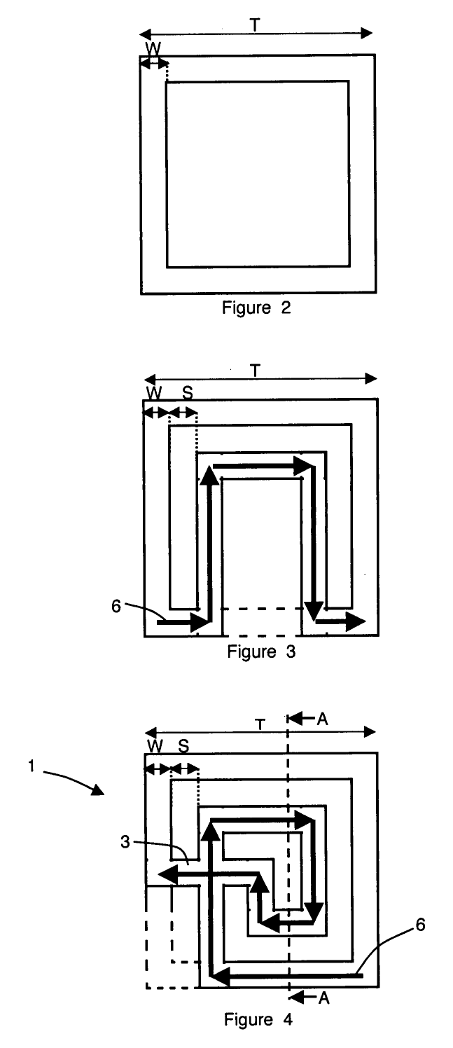

As illustrated by means of FIGS. 2 to 4, the magnetic core 1 enables the space occupation in the centre of the core 1 and of the corresponding micro-inductor to be maximized.

The length I of the magnetic core corresponding to the developed length of the magnetic circuit and the number N of winding turns surrounding the magnetic core 1 are defined. The following expressions can be shown, by means of the reluctances model (L being the inductance and Iₛₐₜ the saturation current):

L˜N²/I,

Iₛₐₜ˜I/N and

LIₛₐₜ²˜I.

Thus, to increase the saturation power Pₛₐₜ=LIₛₐₜ² of the inductor, it is sought to increase the length I of the magnetic core. The inductance L and the saturation current Iₛₐₜ therefore result from a trade-off on the number of winding turns N, which is greater the greater the length I of the core.

An annular inductor according to the prior art, represented in FIG. 2, is particularly suitable for a square chip. The length of the developed loop depends on the external perimeter of the chip. This geometry does not enable the central part of the chip to be used.

FIG. 3 represents an improvement of the annular inductor, the meandered inductor described in the above-mentioned article by Park. The meandered inductor enables the central zone to be used by stretching one of the four branches of the loop so as to form one or more meanders covering the central part. This solution enables the length I of the core to be increased at constant surface. Using conventional design rules, occupation of the central zone by the meandered core (FIG. 3) enables a gain to be obtained on the length I of the core of about 33% compared with the annular core (FIG. 2). By increasing the number N of winding turns according to the length I of the core, a trade-off is obtained with a gain on the inductance L of about 20% and a gain on the saturation current Iₛₐₜ of about 10%.

However, the inductor in meander form is only optimal in particular cases where the width of the loop and the width of the branches verify certain geometry conditions. The central zone does in fact have to be sufficiently large to enable an integer number of meanders to be inserted.

As represented in FIG. 3, the core has a global width T, the branches have a width W and the distance separating two adjacent branches must be greater than a minimum separating distance S. Thus, for a given number Nm of meanders, the global width T of the core must fulfil the condition:

T≧2 W+Nm*2 W+(2 Nm+1)*S.

The ratio of the number Nm of meanders over the surface of the central zone is maximized when the left part and the right part of the equation are equal:

T=2 W+Nm*2 W+(2 Nm+1)*S.

Admitting that the width W of the branches and the minimum separating distance S are equal (S═W), the condition is simplified:

T/W≧3+4 Nm,

where T/W is the ratio of the global width T over the width W of the branches. For T/W=7, 11, 15 . . . , the meandered core therefore enables the central zone to be filled optimally. For T/W=9, 13, 17 . . . however, a large part of the central zone remains unused. Implementation of meandered cores is therefore restrictive in practice as the size of the chip and the width of the branches are in general imposed independently. A part of the central zone can thus remain unused.

The spiral-shaped closed magnetic core 1 presents a greater independence as far as dimensional constraints are concerned, and therefore enables the length I of the core, the inductance L and the saturation current Iₛₐₜ to be optimized for any given surface. As before, the gain on the length of the core 1 and the gain in power of the spiral-shaped core (FIG. 4) can be evaluated with respect to the reference annular structure (FIG. 2). Two cases then have to be differentiated:
When the ratio T/W is essentially equal to the right side of the above equation, i.e. when

T/W≈3+4 Nm(=7, 11, 15),
the spiral-shaped closed core and the looped core are comparable, as the gain on the length and the gain on the power are comparable.
When the above equation is not verified, the closed spiral core enables a larger gain in length I and gain in power to be obtained than the looped core, for example for T/W comprised between 8 and 10 (8<T/W<10) or for T/W comprised between 12 and 14 (12<T/W<14).

In particular, in the case of a ratio T/W=9, the spiral core (FIG. 4) enables a gain of 53% on the length I and on the power to be obtained compared with the annular shape (FIG. 2).

The branches and the closing segment 3 have a preferred direction of dynamic propagation of the magnetic flux. The magnetic axes of the branches and of the closing segment 3 are oriented with respect to one another in such a way as to obtain a flux in the form of a closed loop as represented in FIG. 4 by the arrows 6.

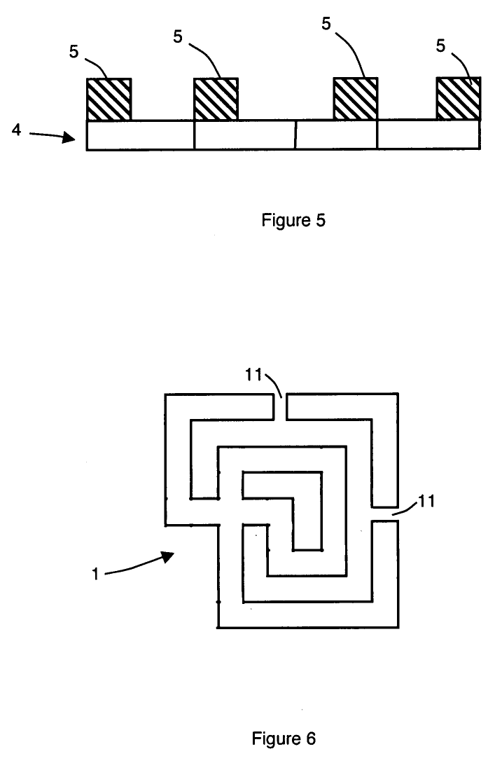

The branches can be arranged in different parallel planes. Thus, as represented in FIG. 5, the first set 4 of parallel branches is arranged in a first plane and the second set 5 of parallel branches is arranged in a second plane parallel to the first plan and above the first plane in FIG. 5. Moreover, the branches can have different thicknesses. Thus, in FIG. 5 the branches of the first set 4 are less thick than the branches of the second set 5. This in particular enables the core to be adapted to the local constraints of the chip used and of the adjacent electronic components.

One or more air-gaps may cut the magnetic core 1 to increase the reluctance of the magnetic circuit. The magnetic core 1 represented in FIG. 6 comprises several air-gaps 11 of small dimension (at least a factor 1/10 between the dimension of the air-gap and the total length of the magnetic circuit). The air-gaps can be arranged in one or more of the branches.

As represented in FIGS. 1, 4 and 6, the branches form a rectangular or substantially rectangular spiral, having two windings inscribed in two concentric rectangles. However, depending on requirements, more complex spirals may be envisaged. Different shapes can be realized, for example the geometry of the spiral is rectangular, round, square or octagonal. The man of the trade determines the particular shape using simulation software such as the Flux software from Cedrat or the Maxwell software from Ansoft.

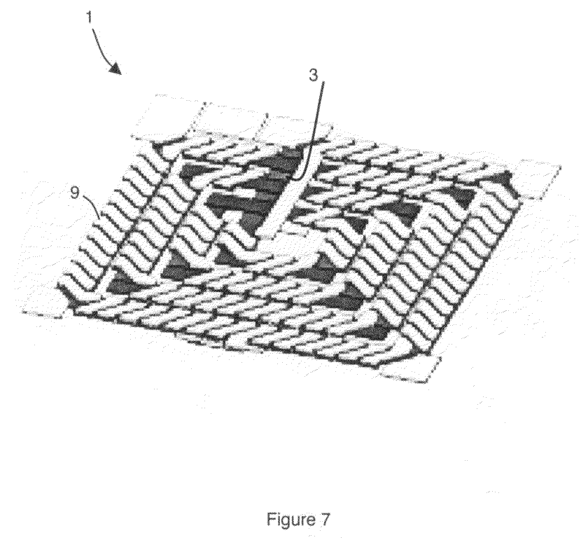

FIG. 7 illustrates a micro-inductor comprising the magnetic core 1 according to the invention. A plurality of non-joined turns 9 form a coil around the magnetic core 1. All the branches of the core can comprise winding turns. The turns preferably envelop almost all of the surface of the magnetic core 1, a minimum isolating gap separating adjacent turns. Each turn can comprise a bottom flat section in a bottom plane, a top flat section in a top plane and two rising sections. The coil preferably comprises a single electric input and a single electric output. The closing segment 3 preferably does not comprise any turns 9.

For integrated components using conventional micro-fabrication techniques, the micro-inductor does not present any additional manufacturing difficulties as compared with already existing conventional systems.

For the magnetic core 1, high-permeability (more than 10) magnetic materials are used, typically iron-(Fe) and/or nickel-(Ni) and/or cobalt-base (Co) alloys able to contain one or more of the following elements: aluminium (Al), silicon (Si), tantalum (Ta), hafnium (Hf), nitrogen (N), oxygen (O) and boron (B). The core can be heterogeneous and forms one or more ferromagnetic and conducting or dielectric (non magnetic) or antiferromagnetic layers. In particular, the core can be formed by an alternation of magnetic layers and intermediate layers, for example a stack comprising two magnetic layers separated by an intermediate layer. The intermediate layers can for example be made of metal (copper Cu, titanium Ti or ruthenium Ru for example) or of an insulating material such as silicon oxide SiO₂ or aluminium oxide Al₂O₃ for example. The intermediate layers can also be formed by antiferromagnetic materials such as nickel oxide NiO or manganese (Mn) alloys comprising nickel (NiMn), iridium (IrMn) or platinum (PtMn).

The micro-inductor is not limited in its frequency of use and could be suitable for uses at high frequency, which always require more power. Such components can therefore very easily be imagined working in the microwave range and replacing the integrated or discrete inductors, with or without magnetic material, which are usually used. Applications of the filtering, impedance matching, etc. type are then to be found.

We claim:

1. A closed magnetic core for an integrated micro-inductor, wherein it is in the form of a spiral comprising two ends joined to one another by a closing segment.

2. The magnetic core according to claim 1, wherein it has a rectangular spiral form.

3. The magnetic core according to claim 1, wherein the magnetic core is formed by a plurality of branches.

4. The magnetic core according to claim 3, wherein at least two branches are arranged in different parallel planes.

5. The magnetic core according to claim 4, wherein a first set of parallel branches is arranged in a first plane and a second set of parallel branches is arranged in a second plane.

6. The magnetic core according to claim 5, wherein the branches of the first set of parallel branches are substantially perpendicular to the branches of the second set of parallel branches.

7. The magnetic core according to claim 3, wherein at least two branches have different thicknesses.

8. The magnetic core according to claim 1, comprising at least one air-gap.

9. An integrated micro-inductor, comprising a magnetic core according to claim 1.
